(19) United States
(12) Patent Application Publication
(10) Pub. No.: US 2011/0168745 A1
(43) Pub. Date: Jul. 14, 2011

(54) Spraying Apparatus and Method of Using the Same

(75) Inventors: David Bedford, Hull (GB); Martin Butler, Hull (GB)

(73) Assignee: Reckitt Benckiser (UK) Limited, Slough (GB)

(21) Appl. No.: 12/913,346

(22) Filed: Oct. 27, 2010

Related U.S. Application Data
(63) Continuation of application No. 11/572,428, filed on May 11, 2007, now abandoned.

(30) Foreign Application Priority Data
Jul. 28, 2004 (GB) 0416801.9

(51) Int. Cl. B65D 83/14; B05B 1/00

(52) U.S. Cl. 222/635; 239/589

(57) ABSTRACT

An outlet head (22) for a spray device (10), the outlet head (22) comprising an inlet section (31) having an opening (30) adapted to receive an output section (20) of a spray material container (16), said opening (30) forming a first end of a fluid channel for spray material from the spray material container (16), the outlet head (22) also comprising an outlet portion (14) adapted to eject spray material and forming a second end of the fluid channel for spray material, wherein the inlet section (31) has a first, major, lateral axis and a second, minor, lateral axis, said first and second axes being substantially at right angles to one another, wherein the size of the inlet section along the first, major, axis is greater than the size of the inlet section along the second, minor, axis.

This invention relates to an apparatus for spraying a fragrance, a pest control material, a deodorizing fluid, or similar, and to a container for use in a spraying apparatus and to a method of spraying.

Prior art devices for spraying fragrances, deodorizing agents and sanitizing fluids into a room consist of a mechanically actuated arm which is periodically activated to press down on a spray head secured to an aerosol canister containing the material to be sprayed.

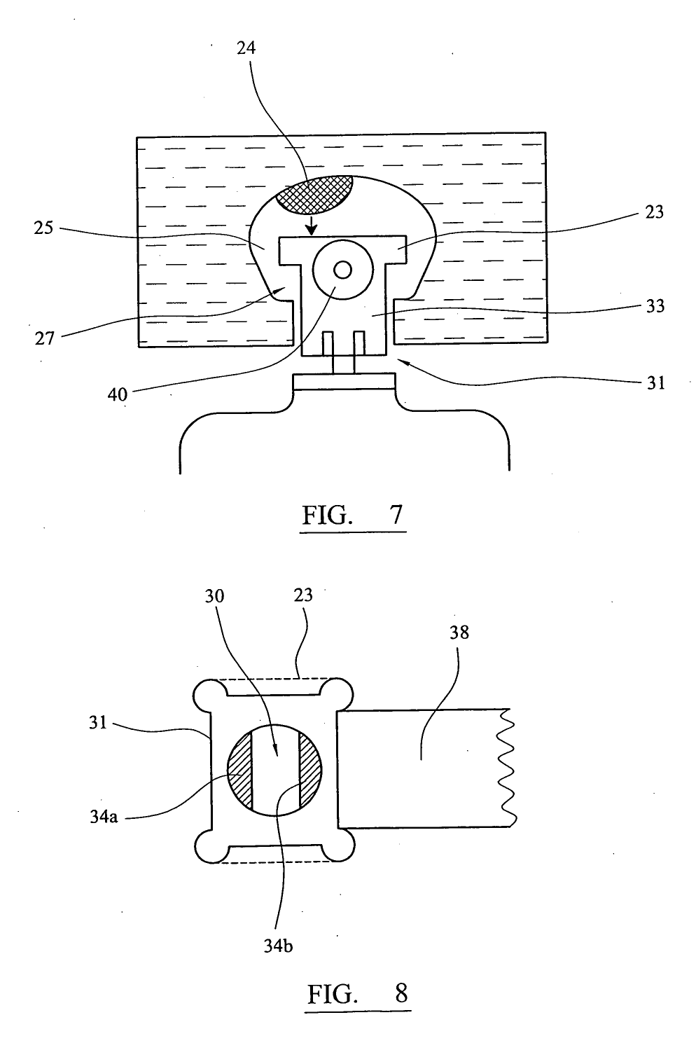

The prior art devices are typically constructed as follows. An outer casing has an opening through which the spray is ejected. The casing has a removable section which is removed to allow a refill canister containing the spray material to be placed in the casing. A moulded spray head, as shown in FIG. 8, is placed over the outlet stalk of an aerosol spray can. The spray head has an inlet section 31 having an opening 30 to be placed over the outlet stalk of the aerosol canister. The inlet section 31 has a square shape with strengthening pillars at corners of the square. Inner shoulders 34a,b bear against the outlet stalk to cause material to be ejected from the canister into the opening 30 and out of an outlet of the spray head (shown in part in FIG. 6). A location block 23 allows location of the spray head in the casing. The actuation arm is located over the spray head and is caused periodically to press against the spray head to cause material from the aerosol can to be ejected through the spray head out of the opening in the casing and into the surroundings. The actuator arm is either battery powered or mains powered and can be set to activate at various time intervals which, for example, may be to activate every seven minutes, every fifteen minutes or every thirty minutes, whichever is set by a user.

It has been found that disadvantages arise with these prior art spraying devices in that the direction of the spray is not well constrained and so the spraying of the material may occasionally miss the opening in the outer casing thereby wasting the spray material and not working efficiently. The spray head may twist sideways away from the outlet in the casing for example.

Furthermore, due to the strength of the movement of the actuation arm required to achieve proper actuation of the aerosol device, there is a tendency for the output stem of the aerosol device to break if there is some mis-alignment between the actuator arm and the aerosol container.

It is an object of the present invention to address the above mentioned disadvantages.

According to a first aspect of the invention there is provided an outlet head for a spray device, the outlet head comprising an inlet section having an opening adapted to receive an output section of a spray material container, said opening forming a first end of a fluid channel for spray material from the spray material container, the outlet head also comprising an outlet section adapted to eject spray material and forming a second end of the fluid channel for spray material, wherein the inlet section has a first, major, lateral axis and a second, minor, lateral axis, said first and second axes being substantially at right angles to one another, wherein the size of the inlet section along the first, major, axis is greater than the size of the inlet section along the second, minor, axis.

Preferably, a distance between outer surfaces of the inlet section along the first, major, axis is greater than a distance between outer surfaces of the inlet section along the second, minor, axis.

Preferably the inlet section is laterally elongate in shape, preferably elongate from front to rear. The shape of the inlet section advantageously deters rotation of the spray head with respect to a remainder of a spray device in which the spray head is adapted to be located.

Preferably the first axis runs substantially between a front and a rear of the inlet section.

Preferably, the opening in the inlet section is generally circular.

Preferably, sidewalls of the inlet section are thicker along the first axis than along the second axis. The thickness of the sidewalls along the first axis advantageously provides strengthening for the inlet section. The relative thinness of the sidewalls along the second axis advantageously provides a reduction in material required for the inlet section.

The ratio of wall thickness along the first axis to the wall thickness along the second axis may be greater than approximately 1.25 to 1, preferably greater than approximately 1.5 to 1, more preferably greater than approximately 1.75 to 1, still more preferably greater than approximately 1.8 to 1.

The walls of the second axis preferably have a thickness of between approximately 0.65 mm and 1.05 mm, preferably between approximately 0.75 mm and 0.95 mm. The walls at the first axis may have a thickness of between approximately 1.4 mm and 1.8 mm, preferably between approximately 1.5 mm and 1.7 mm.

The references herein to approximately maybe omitted.

The reference to a spray device and to spray material may be taken to a general reference to a device that is adapted to eject material in a spray, a jet, in droplets or other fluid form; references to spray material should be interpreted in a similar way.

According to a second aspect of the present invention there is provided a spray material container adapted to be received in the opening of the outlet head described in the first aspect.

According to a third aspect of the present invention there is provided a method of spraying material and preventing damage to an output section of a spray material container, wherein the method comprises using an outlet head for a spray device as described in the first and fourth aspects.

The advantageously narrow opening in the outlet head for receiving the output section of the spray material container reduces the risk of breaking the output section. Also there is advantageously reduced relative movement between the outlet head and the output section.

According to a fourth aspect of the present there is provided an outlet head for a spray device, the outlet head comprising an inlet section having an opening adapted to receive an output section of a spray material container, said opening forming a first end of a fluid channel for spray material from the spray material container, the outlet head also comprising an outlet section adapted to eject spray material and forming a second end of the fluid channel for spray material, wherein the inlet section has a cross-section that is laterally elongate.

The invention extends to a spray material container having a spray head as described in the first aspect attached thereto.

The spray material container may be an aerosol canister.

According to a fifth aspect of the invention there is provided an outlet head for a spray device, the outlet head comprising an inlet section having an opening adapted to receive an output section of a spray material container, said opening forming a first end of a fluid channel for spray material from the spray material container, the outlet head also comprising an outlet section adapted to eject spray material and forming a second end of the fluid channel for spray material, wherein the inlet section has a first and second lateral axes, wherein at least one of said axes is less than or equal to approximately 5 mm in length.

Preferably only one of said first and second axes measures less than or equal to approximately 5.5 mm.

Preferably one of said axes measures approximately 5 mm. Preferably the other of said axes measures approximately 6.5 mm.

The invention extends to a spraying device comprising a casing, activation means and an outlet head as described any of the first, fourth or fifth aspects.

According to another aspect of the invention there is provided an outlet head for a spray device, the outlet head comprising:
an inlet section having an opening adapted to receive an output section of a spray material container, said opening forming a first end of a fluid channel for spray material from the spray material container; and
an outlet section adapted to eject spray material and forming a second end of the fluid channel for spray material; wherein
the inlet section has a first, major, lateral axis and a second, minor, lateral axis, said first and second axes being substantially at right angles to one another; and wherein
a distance between outer surfaces of the inlet section along the first, major, axis is greater than a distance between outer surfaces of the inlet section along the second, minor, axis.

According to another aspect of the invention there is provided an outlet head for a spray device, the outlet head comprising:
an inlet section having an opening adapted to receive an output section of a spray material container, said opening forming a first end of a fluid channel for spray material from the spray material container; and
an outlet section adapted to eject spray material and forming a second end of the fluid channel for spray material; wherein
the inlet section has an external cross-section that is laterally elongate.

According to another aspect of the invention there is provided an outlet head for a spray device, the outlet head comprising:
an inlet section having an opening adapted to receive an output section of a spray material container, said opening forming a first end of a fluid channel for spray material from the spray material container; and
an outlet section adapted to eject spray material and forming a second end of the fluid channel for spray material; wherein
the inlet section has a first and second lateral axes, wherein a distance between external surfaces of the inlet section along at least one of said axes is less than or equal to approximately 5 mm.

All of the features described herein may be combined with any of the above aspects, in any combination.

For a better understanding of the invention, and to show how embodiments of the same may be carried into effect, reference will now be made, by way of example, to the accompanying diagrammatic drawings in which:

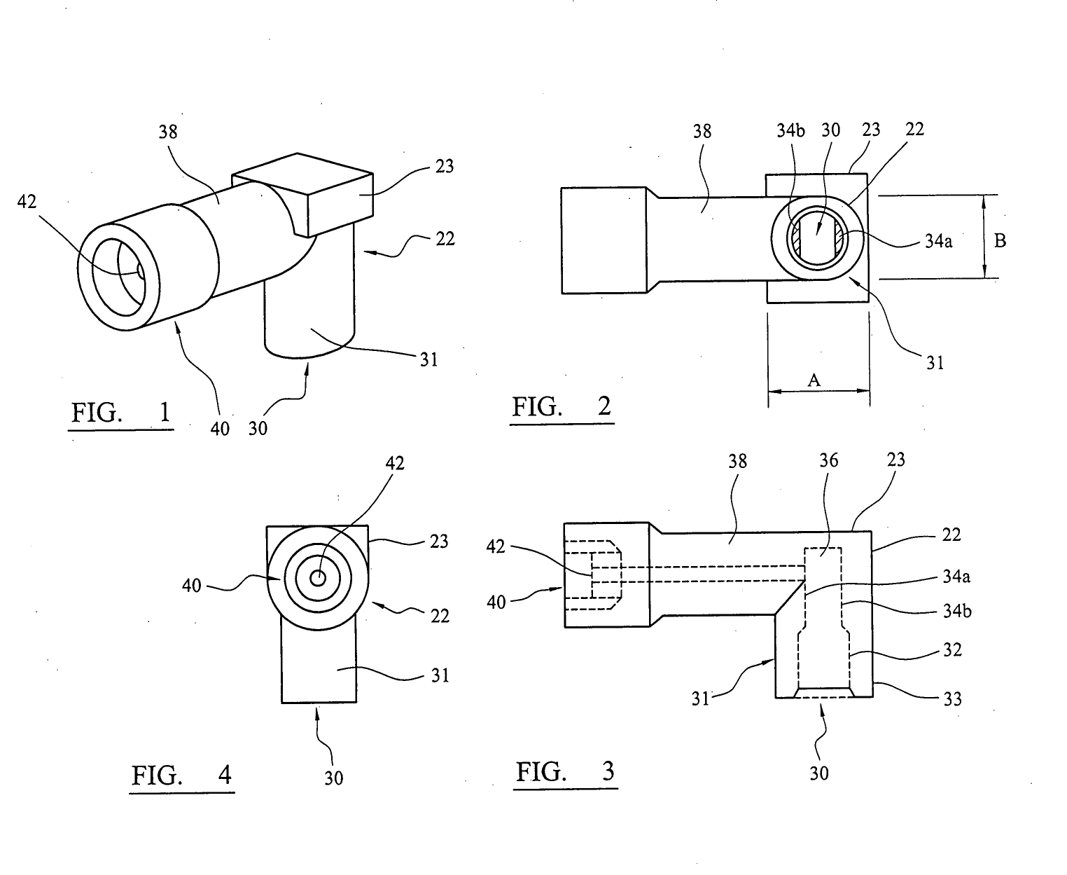

FIG. 1 is a schematic perspective view of a spray head section of a spraying device;

FIG. 2 is a view from below of the spray head shown in FIG. 1;

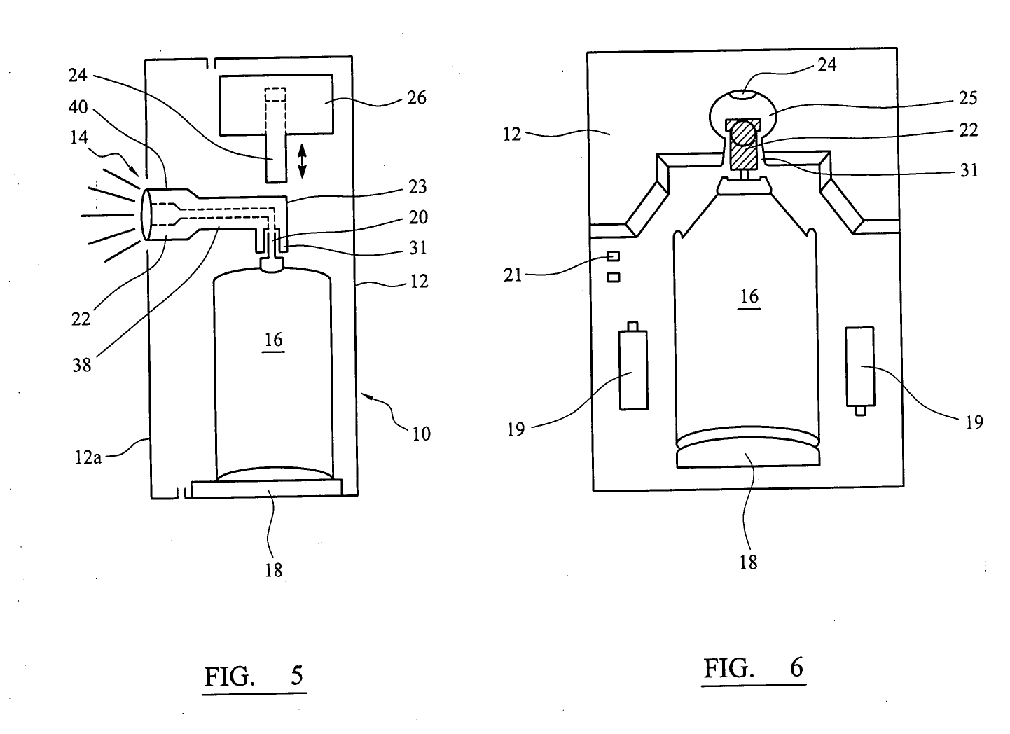

FIG. 3 is a schematic cross-sectional view of the spray head;

FIG. 4 is a schematic front view of the spray head;

FIG. 5 is a schematic view of a spraying device incorporating the spray head shown in FIGS. 1 to 4;

FIG. 6 is a schematic front view of the spraying device shown in FIG. 5;

FIG. 7 is a schematic partial front view of the spray head in position in a spraying device; and

FIG. 8 is a schematic view from below of a prior art spray head, corresponding to the view of the spray head shown in FIG. 2.

It has been found that there are some shortcomings in the existing design of spray heads used in prior art types of fragrance spraying device. Firstly, there is some relative movement (primarily a rotation about a vertical axis) between the spray head typically used and the outlet stem of an aerosol canister. This, in conjunction with the forceful movement of the actuator arm, can result in the outlet stem being pushed at an unintended angle and causing fracture or snapping of the outlet stem, which causes the spraying device to malfunction. Also, it has been found that the play between the prior art spray head and the outlet stem of the aerosol canister can cause misdirection of this spray causing it to impinge on the housing of the spraying device, rather than exiting the opening as intended.

As shown in FIGS. 5 and 6 a fragrance spraying device 10 comprises a housing 12 in a removable front section 12a of which there is an opening 14. An aerosol spray canister 16 is held within the housing 12 on a platform 18. An outlet stem 20 of the spray canister 16 is received in a lower opening in a spray head 22, the details of which will be discussed below. An actuator arm 24 is located above the spray head 22 and is moveable by an actuator 26 to move down onto the spray head 22 and cause activation of the aerosol spray canister 16 to spray material from the opening 14. The actuator 26 is powered by batteries 19 and may have an adjustment control 21.

In use, the aerosol spray canister 16 is placed on the platform 18 and the outlet stem 20 is engaged in a lower opening 30 in the spray head 22. The aerosol spray canister 16 is a replaceable item, whilst the spray head 22 is typically supplied with the aerosol spray canister 16.

When the aerosol spray canister 16 is placed in position a fluid path for fragrance (or sterilizing material or other material) for spraying is formed from the aerosol spray canister 16 through the spray head 22 to the opening 14 in the front section of the housing 12a and out into the surrounding atmosphere.

In order to cause spraying of the material within the aerosol spray canister 16 the actuator arm 24 is caused to move down onto the spray head 22 by the actuator 26. The actuator 26 has numerous selectable settings which a user may select with use of the adjustment control 21. The settings may be, for example to cause the actuator arm 24 to move and cause spraying from the aerosol spray canister every nine minutes, every eighteen minutes, every thirty-six minutes or any other of the large number of possible settings, as would be preferred by a user.

In order to locate the spray head 22 with respect to the casing 12 the spray head 22 has a location block 23 above a lower, inlet, section 31 of the spray head 22. The location block 23 is received in a location section 25 of the casing 12, shown in FIG. 7. The location section 25 receives the location block 23, the latter being wider than the inlet section 31. The inlet section 31 is received in a neck section 27 (beneath the location block 25) of the casing 12, which neck section 27 has a close fit with the inlet section 31. Space is allowed below the location block 25 to allow for vertical movement of the spray head 22 relative to the neck 27 when it is activated, so that it does not bear against the top of the neck section 27 when spraying.

It may alternatively be preferable to hold the spray head 22 in position and use the actuator 26 and actuator arm to bear on the canister 16, from beneath. This may result in better accuracy of spray direction.

With the above mentioned shortcomings of prior art devices in mind the revised spray head 22 as shown in FIGS. 1 to 5 has been designed. In order to reduce the relative movement between the spray head 22 and the outlet stem 20 of the aerosol spray canister 16 it has been found surprisingly that great improvements in direction of the spray and reducing the risk of fracture or breakage of the outlet stem can be achieved. In particular a narrowing of the inlet section 31 compared to a prior art spray head and a narrowing of the neck section 27 of the casing provides better constraint of relative movement between the spray head 22 and the casing 12.

The lower opening 30 in the spray head 22 has a chamfered mouth which tapers inward at an angle of 45° to an inner diameter of 2.8 mm. This diameter is less than is typically used in prior art spray heads (which typically have a width of 3.2 mm or 3.0 mm).

As shown in FIG. 2, the inlet section 31 has a generally oval cross-section, instead of the square shape with strengthening corner posts of the prior art shown in FIG. 6.

From the opening 30 the neck section extends to a shoulder section 32 formed by side walls 34a and 34b. As can be seen from FIG. 2 the shoulder section 32 changes the shape of the channel from a circular cross-section at the lower opening 30 to a generally oval cross-section above the shoulder section 32. The shoulder section 32 allows the outlet stem 20 of the aerosol spray canister 16 to bear against the shoulder section when pressure is exerted and thereby release material from the aerosol canister 16. The shoulder section 32 causes the width of the passage extending through the spray head 22 to narrow to 2.3 mm. From the shoulder section 32 the side walls 34a/b extend upwards continuing the channel through a bend 36 along a horizontal section 38 to a mouth section 40. The mouth section 40 forms a convoluted path through which the material from the aerosol spray canister 16 must pass in order to form a spray of the material to exit the mouth section 40. An insert 42 is present in the mouth section 40 in order to break up this spray.

As can be seen from FIG. 5, the mouth section 40 is aligned with the opening 14 in the housing 12 to allow greater accuracy of ejection of material from the aerosol canister through the opening 14, particularly when the location block 23 is received in the location bracket 25 and the canister 16 is pushed from below.

It has been found that significant advantages have resulted by selectively thickening the side walls 33 of the inlet section 31, in particular the walls 33 at the front and rear of the inlet section 31 as they extend up to the shoulder section 32. The thickening of the walls has resulted in a generally elongate shape from front to rear. This shape deters relative rotation about a vertical axis between the spray head 22 and the neck section 27 of the casing 12. At the sides the walls are approximately 0.85 mm thick, whereas at front and back the walls are approximately 1.6 mm thick. Thus there is a ratio of approximately 1.9 to 1 between the wall thicknesses. This results in considerably less likelihood of misdirection of spray material and/or fracture of the outlet stem 20 in the event that there is mis-alignment of the spray head 22 as the actuator arm 24 presses against the spray head 22, or presses against the canister 16, whichever is the case. In addition, the thinning of the walls at the sides of the inlet section 31 serves to accentuate the oval shape thereof and further reduce the relative relation referred to above. The thinning allows the amount of material used to be reduced, because of the thickening at the front and rear walls.

In order to compensate for the thickening of the walls 33 it has been necessary to make some reduction in the width of the outlet stem 20 of the aerosol spray canister 16 to 2.8 mm so that the outlet stem 20 can still be received in the opening 30 in the spray head 22.

There is a surprising effect achieved by a relatively small thickening of the front and rear walls 33 of the inlet section 31 on the spray head 22. The advantages of greater accuracy of spray and less likelihood of breakage of the outlet stem 20 are significant in a product such as this in which reliable use is required by users.

The aerosol spray canister 16 with the reduced width of outlet stem 20 can be used in conjunction with the spray head 22 described herein, but can also be used with prior art spray heads used with prior art apparatus. Thus, although amendments have been made to a relatively standard design there is no reduction in functionality for the aerosol spray canisters 16 which are usable with the outlet stem 20 described herein.

As described above, the walls 33 have been thickened at the front and rear and thinned at the sides to provide a shape longer from front to back than it is wide. The outer width of the inlet section 31 at the point marked A in FIG. 2 is 6.5 mm. The width taken at 90° to this shown at B in FIG. 2 is 5 mm, which is also the thickness of a first part of the horizontal section 38.

As mentioned above, the main requirement of the lower opening 30 is to reduce the amount of relative movement between the spray head 22 and the casting 12, as well as the outlet stem 20, because of the surprisingly beneficial effects of doing so. Increasing the thickness of the walls 33 selectively, preferably at front and rear, provides the advantages referred to above.

Reference is made in this specification to the spraying device 10 being a fragrance spraying device. The spraying device 20 may also be used for spraying deodorizing material, sanitizing materials or any other material in a spray form. The apparatus described is typically for use in periodic spraying into a closed area such as a room. The apparatus is also being described in relation to the use of an aerosol spray canister 16 for the material to be sprayed. However, different types of container other than an aerosol canister could be used.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An outlet head for a spray device comprising:
an inlet section having an opening adapted to receive an output section of a spray material container, said opening forming a first end of a fluid channel for spray material from the spray material container; and
an outlet section adapted to eject spray material and forming a second end of the fluid channel for spray material; wherein
the inlet section has a first, major, lateral axis and a second, minor, lateral axis, said first and second axes being substantially at right angles to one another; and wherein
a distance between outer surfaces of the inlet section along the first, major, axis is greater than a distance between outer surfaces of the inlet section along the second, minor, axis.

2. An outlet head for a spray device as described in claim 1, in which the inlet section is laterally elongate in shape from front to rear.

3. An outlet head for a spray device as claimed in either claim 1 or claim 2, in which sidewalls of the inlet section are thicker along the first axis than along the second axis.

4. An outlet head for a spray device as claimed in any preceding claim, in which the ratio of wall thickness along the first axis to wall thickness along the second axis is greater than approximately 1.25 to 1.

5. An outlet head for a spray device as claimed in any preceding claim, in which the walls along the second axis have a thickness of between approximately 0.65 mm and 1.05 mm

6. An outlet head for a spray device as claimed in any preceding claim, in which the walls along the first axis have a thickness of between approximately 1.4 mm and 1.8 mm.

7. An outlet head for a spray device, the outlet head comprising:
an inlet section having an opening adapted to receive an output section of a spray material container, said opening forming a first end of a fluid channel for spray material from the spray material container; and
an outlet section adapted to eject spray material and forming a second end of the fluid channel for spray material; wherein
the inlet section has an external cross-section that is laterally elongate.

8. An outlet head for a spray device, the outlet head comprising:
an inlet section having an opening adapted to receive an output section of a spray material container, said opening forming a first end of a fluid channel for spray material from the spray material container; and
an outlet section adapted to eject spray material and forming a second end of the fluid channel for spray material; wherein
the inlet section has a first and second lateral axes, wherein a distance between external surfaces of the inlet section along at least one of said axes is less than or equal to approximately 5 mm.

9. An outlet head for a spray device as claimed in any preceding claim, in which an internal cross-section of at least part of the inlet section is generally circular.

10. An outlet head for a spray device as claimed in claim 9, in which the internal cross-section is the cross-section of the opening adapted to receive an output section of a spray material container.

11. A spray material container adapted to be received in the opening of the outlet head claimed in any one of claims 1 to 10.

12. A method of spraying material and preventing damage to an output section of a spray material container, wherein the method comprises ejecting material from an aerosol container using an outlet head for a spray device as claimed in any one of claims 1 to 10.

13. A spray material container having a spray head as claimed in any one of claims 1 to 10 attached thereto.

14. A spraying device comprising a housing, activation means and an output section as claimed in any one of claims 1 to 10.

15. A spraying device substantially as described herein with reference to FIGS. 1 to 7 of the drawings.
